(19) United States
(12) Patent Application Publication
(10) Pub. No.: US 2012/0191379 A1
(43) Pub. Date: Jul. 26, 2012

(54) IMPACT SENSING AND RECORDING

(75) Inventors: Changying Li, Tifton, GA (US); Pengcheng Yu, Gainesville, GA (US)

(73) Assignee: UNIVERSITY OF GEORGIA RESEARCH FOUNDATION, INC., Athens, GA (US)

(21) Appl. No.: 13/357,186

(22) Filed: Jan. 24, 2012

Related U.S. Application Data
(60) Provisional application No. 61/435,390, filed on Jan. 24, 2011.

(51) Int. Cl. G06F 19/00

(52) U.S. Cl. 702/41

(57) ABSTRACT

Various methods and systems are provided for impact sensing and recording. In one embodiment, an impact recording sensor includes an impulse sensing system configured to sense impacts experienced by the impact recording sensor in three dimensions and a microcontroller unit (MCU) configured to obtain impact data from the impulse sensing system and store an impact data set including the impact data in memory in response to an impact experienced by the impact recording sensor. The impact recording sensor may also include a rechargeable power source configured to supply power to the MCU. In another embodiment, an impact recording system includes and impact recording sensor and a control interface unit configured to communicatively couple with the impulse recording sensor. The control interface unit may be configured to download impact data set stored in memory of the impulse recording sensor.

### CROSS REFERENCE TO RELATED APPLICATIONS

This application claims priority to copending U.S. provisional application entitled “IMPACT SENSING AND RECORDING” having Ser. No. 61/435,390, filed Jan. 24, 2011, the entirety of which is hereby incorporated by reference.

### STATEMENT REGARDING FEDERALLY SPONSORED RESEARCH OR DEVELOPMENT

This invention was made with government support under agreement 2008-51180-19579 awarded by the USDA National Institute of Food and Agriculture. The Government has certain rights in the invention.

### BACKGROUND

Bruising caused by the impact damage can occur frequently during the mechanical harvesting of fruits and vegetables. Monitoring the impact during the mechanical harvesting process can aid in improvements to the process and/or equipment that may reduce and/or eliminate the bruising.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graphical representation of an example of an impact recording (IR) system according to various embodiments of the present disclosure.

FIG. 2 is an example of a physical layout of the IR sensor in the IR system of FIG. 1 according to various embodiments of the present disclosure.

FIG. 3 is a picture illustrating an example of the relative size of the main printed circuit board of the IR sensor of FIG. 2 according to various embodiments of the present disclosure.

FIGS. 4 and 5 are diagrams illustrating examples of electronic circuitry included in the IR sensor of FIG. 2 according to various embodiments of the present disclosure.

FIGS. 6A and 6B are plots illustrating discharging and recharging performance of a battery of the IR sensor of FIG. 2 according to various embodiments of the present disclosure.

FIG. 7 is a diagram illustrating an example of circuitry included in a control interface unit (CIU) in the IR system of FIG. 1 according to various embodiments of the present disclosure.

FIG. 8 is a graphical representation of the data flow between components in the IR system of FIG. 1 according to various embodiments of the present disclosure.

FIG. 9 is a diagram illustrating functions implemented by applications executed by components in the IR system of FIG. 1 according to various embodiments of the present disclosure.

FIG. 10 is a flow chart illustrating an example of a sensor application of FIG. 9 according to various embodiments of the present disclosure.

FIG. 11 is a flow chart illustrating an example of inter-integrated circuit (I2C) communication between the CIU and the IR sensor of FIG. 8 according to various embodiments of the present disclosure.

FIG. 12 is an example of the format of a set of acceleration data for saving into memory of the IR sensor of FIG. 8 according to various embodiments of the present disclosure.

FIG. 13 is a block diagram illustrating an example of writing data into the memory using the hardware SPI protocol according to various embodiments of the present disclosure.

FIG. 14 is a plot illustrating collection of datasets before (leaders), during, and after (trailers) an impact that exceeds a defined threshold according to various embodiments of the present disclosure.

FIG. 15 is a flow chart illustrating an example of impact data sampling and storing included in the flow chart of FIG. 10 according to various embodiments of the present disclosure.

FIG. 16 is a graphical representation of an example of the time used to record one dataset in FIG. 15 according to various embodiments of the present disclosure.

FIG. 17 is a flow chart illustrating an example of an interface application of FIG. 9 according to various embodiments of the present disclosure.

FIGS. 18 and 19 are examples of graphical user interfaces (GUIs) of an IR acquisition application of FIG. 9 according to various embodiments of the present disclosure.

FIG. 20 is a plot illustrating clock error calibration of the IR sensor of FIG. 2 according to various embodiments of the present disclosure.

FIGS. 21A, 21B, and 21C are plots illustrating impact curves recorded at different sampling frequencies by the IR sensor of FIG. 2 according to various embodiments of the present disclosure.

FIGS. 22, 23, and 24 are plots illustrating testing performance of the IR sensor of FIG. 2 according to various embodiments of the present disclosure.

### DETAILED DESCRIPTION

Disclosed herein are various embodiments related to impact sensing and recording. Reference will now be made in detail to the description of the embodiments as illustrated in the drawings, wherein like reference numbers indicate like parts throughout the several views.

In general, an impact recording system includes an impact recording (IR) sensor for sensing and recording impulses experienced by the impact recording sensor and a control interface unit for accessing the recorded impulse data. The impact recording sensor includes an impulse sensing system for sensing impacts in three dimensions, a microcontroller unit (MCU) that obtains impact data from the impulse sensing system and stores an impact data set including the impact data in memory, and a rechargeable power source. In the monitoring of small fruits, such as blueberries, and other small agricultural produce, the impact recording sensor can be about one inch in diameter or less to simulate the produce size. A computing device may also be included to access and retrieve impact data sets stored in memory of the impact recording sensor and/or the control interface unit. The computing device may also be used to setup the operational settings of the impact recording sensor and/or the control interface unit.

When monitoring a process, the impact recording sensor obtains impact data from the impulse sensing system at a predefined sampling frequency. The impact recording sensor obtains impact data from the impulse sensing system at a sampling time and compares the impact data to a predefined threshold. In some implementations, a vector sum of the impact data is determined and compared to the predefined threshold. An impact data set including the impact data is stored in memory in response to the comparison. A series of impact data sets including impact data sets corresponding to a predefined number of sampling times preceding the sample time where the impact data exceeds the predefined threshold may be stored in response to the comparison. A number of impact data sets corresponding to a plurality of sampling times following the sample time where the impact data exceeds the predefined threshold may also be stored in memory. The stored impact data sets may also include impact time information. The impact data sets may be associated with a leader portion, an impact portion, and a trailer portion of the sensed impact. The control interface unit may be communicatively coupled to the impact recording sensor to access and/or download the stored impact data sets. The computing device may be communicatively couple to the control interface unit and/or the impact recording sensor to access and/or download the stored impact data sets, setup operational settings, and provide other features such as data analysis and rendering as discussed in the appendices. In some implementations, the control interface unit may be included in the computing device.

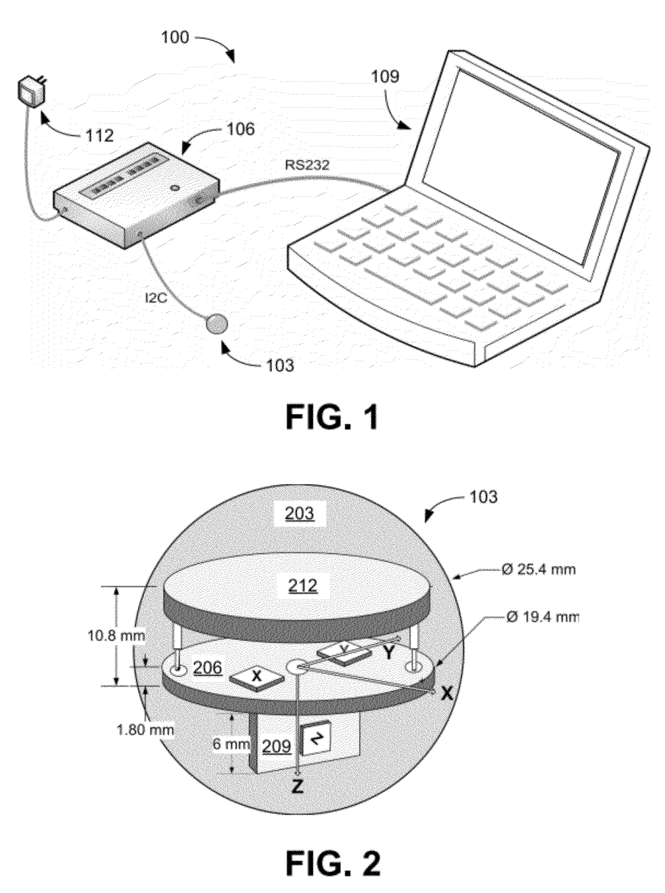

Referring to FIG. 1, shown is a graphical representation of an example of an impact recording (IR) system 100 in accordance with various embodiments of the present disclosure. In the example of FIG. 1, the IR system 100 includes an impact recording (IR) sensor 103, a control interface unit (CIU) 106, and a computing device 109 such as, e.g., a personal computer (PC), laptop computer, tablet, or other appropriate processing device. The IR sensor 103 may be used for impact data collection and recording. The CIU 106 may be communicatively coupled to the IR sensor 103 to download the collected impact data from the IR sensor 103. For example, the IR sensor 103 may be detachably connected to the CIU 106 with a five pin connector, which may be used to set up an inter-integrated circuit (I2C) communication link and provide power to the IR sensor 103. Power for the CIU 106 may be provided by an external power supply 112 such as, e.g., a plug-in DC power supply or an internal DC source. The computing device 109 may be communicatively coupled to the CIU 106 to retrieve and analyze the impact data. For example, the CIU 106 may be detachably connected to the computing device 109 via an RS232 cable, USB cable, etc. In some embodiments, the CIU 106 may be included in the computing device 109. An IR acquisition application executed by the computing device 109 may be used to retrieve and analyze impact data collected by the IR sensor 103. The IR acquisition application may also provide for configuration and control of the IR sensor 103 and/or CIU 106.

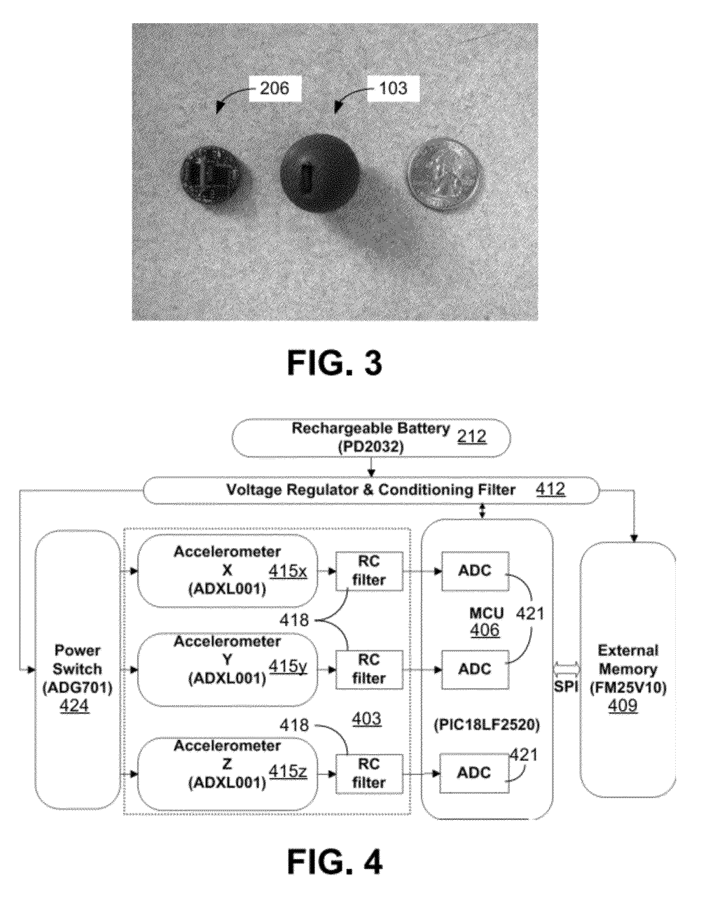

The IR sensor 103 includes an impulse sensing system, electronic circuitry, and a rechargeable power source such as, e.g., a rechargeable battery, which are encased in a spherical housing of, e.g., silicon rubber with a diameter of about one inch (about 25.4 mm). Other sizes may be utilized to simulate smaller fruit or vegetables such as, e.g., blueberries. For instance, the size of IR sensor 103 may be in the range of about 15 mm to about 25 mm. FIG. 2 illustrates an example of a physical layout of the IR sensor 103. In the embodiment of FIG. 2, the spherical housing 203 includes a main printed circuit board (PCB) 206 and a secondary PCB 209 mounted orthogonal to the main PCB 206. The impulse sensing system includes three single-axis accelerometers: x-axis and y-axis accelerometers mounted on the main PCB 206 and a z-axis accelerometer mounted on the secondary PCB 209. In addition, a rechargeable battery 212 (e.g., a coin cell) is mounted within the spherical housing 203. For example, the rechargeable battery 212 may be mounted a fixed distance away from and substantially parallel with the main PCB 206 as depicted in FIG. 2. FIG. 3 is a picture illustrating an example of the relative size of the main PCB 206 with a diameter of about 19.4 mm or about 0.75 inch, the IR sensor 103 with a diameter of about 25.4 mm or about one inch, and a quarter. The PCB is designed to minimize board size. Layout of components on the top and bottom surfaces and the use of a plurality of layers (e.g., 6) in the PCB circuit board enable the design of a miniaturized round board.

Referring next to FIG. 4, shown is a block diagram illustrating an example of the electronic circuitry included in the IR sensor 103. In the embodiment of FIG. 4, the electronic circuitry includes an impulse sensing system 403, a microcontroller (MCU) 406, an external memory 409, and a power source control 412 to regulate and filter power from the rechargeable battery 212. The impulse sensing system 403 includes a tri-axis accelerometer with an appropriate sensing range for the IR sensor 103. Specifically, the IR sensor should provide the appropriate duration, sampling frequency, and accuracy for the monitored process or application. For example, preliminary test showed that the impact duration for blueberry processing lasts for about 3 ms to about 4 ms. Based on Nyquist Sampling theorem, a minimum sampling frequency of 668 Hz avoids aliasing effect. In addition, the sensing range of the accelerometer should also be adequate to record all impacts. Preliminary laboratory test and previous literature indicated that ±500 g range is appropriate to record impact data from blueberries. Adequate power source, accurate real time clock (RTC), and sufficient data storage space are also considerations for the electronic circuitry. For example, a power source capability of at least one hour can allow adequate time for data collection. Similarly, a memory size of 128 KB or more is desirable in order to record the impact data.

In the embodiment of FIG. 4, the impulse sensing system 403 includes three single-axis integrated microelectromechanical systems (iMEMS) accelerometers 415 such as, e.g., fifth-generation iMEMS chip ADXL001 accelerometers (Analog Devices, Norwood, Mass.). The ADXL001 accelerometer provides a ±500 g dynamic range with resolution of 2.2 mV/G, maximum 22 KHz resonant frequency, high linearity, 5000 g impact survival range, and a 5×5×2 mm package size. The ADXL001 sensor can be operated at low voltage (about 3.3 V) and has low power consumption (about 2.5 mA), which is an important consideration in this design. The x-axis and y-axis sensing accelerometers 415x and 415y are mounted on the surface of the main PCB 206 (FIG. 2) with their sensing axes perpendicular to each other. The third accelerometer 415z is mounted on the secondary PCB 209 (FIG. 2) in the z-axis orthogonal to the main PCB 206. In other embodiments, the impulse sensing system may include an integrated (single-chip) three-axis accelerometer; however single-axis accelerometers are available with larger dynamic ranges. For example, integrated digital MEMS three-axis accelerometers such as a STMicroelectronics LIS331H offers ultra-low power consumption (250 μA at active mode), miniature package size (3×3×1 mm), and a dynamic range of ±24 g. RC filters 418 may be included at the output of the accelerometers 415 to aid in sampling by an analog-to-digital converter (ADC) 421.

The MCU 406 acts as the central processing unit of the IR sensor 103. As such, the MCU 406 collects analog acceleration signals from the accelerometers 415, converts them into digital values (ADC 421), and writes (e.g., serially) the data into the external memory 409. It also manages power and communicates with the CIU 106 (FIG. 1). Operational speed, physical dimensions, power consumption and, input/output (I/O) resources are important considerations in the selection of the MCU 406. In the example of FIG. 4, a PIC18LF2520 microcontroller (Microchip, Chandler, Ariz.) was utilized. The PIC18LF2520 chip has 28 pins with 25 I/O pins and 5 channels of 10-bit AD conversion (ADC 421). With a 20 MHz oscillator option, the chip can execute up to 5 million instructions per second (MIPS). Working voltage ranges from 2.0V to 5.5V and the current drain of the PIC18LF2520 MCU in sleep mode can be down to 0.1 μA at 25° C. thanks to its nanoWatt technology. The PIC18LF2520 chip includes 32 KB program memory and 1536 bytes of Static Random Access Memory (SRAM). The large RAM memory enables the buffer to store more array values for recording impact data. It also supports the I2C, the S-wire serial peripheral interface (SPI), and universal asynchronous receiver/transmitter (USART) communication protocols. The size of the chip is 6×6×1 mm with a quad flat no leads (QFN) package.

External memory 409 may be selected based upon criteria including operational speed, communication protocol, package size, and/or power consumption. For example, a Ferroelectric Random Access Memory (F-RAM) chip such as FM25V10 F-RAM (RAMTRON, Colorado Springs, Colo.) may be used. The FM25V10 F-RAM includes serial memory with a 128 KB capacity. It has high writing speed (SPI, 40 MHz), nonvolatile function, and low power consumption (0.3 mA to 3 mA). The physical dimension is 4.9×6.0 mm. Other types of memories may also be used such as, e.g., electrically erasable programmable read-only memory (EEPROM) and the static random access memory (SRAM). Available EEPROM chips can store up to 128 KB data, and also have competitive power and size options. One weakness of the EEPROM chips is its slow writing speed caused by the hardware delay, which takes an additional 5-10 ms for each writing cycle other than the bus writing period. The SRAM traditionally operates at high bus speed, but it does not provide non-volatile feature, which may cause data loss due to potential battery failure.

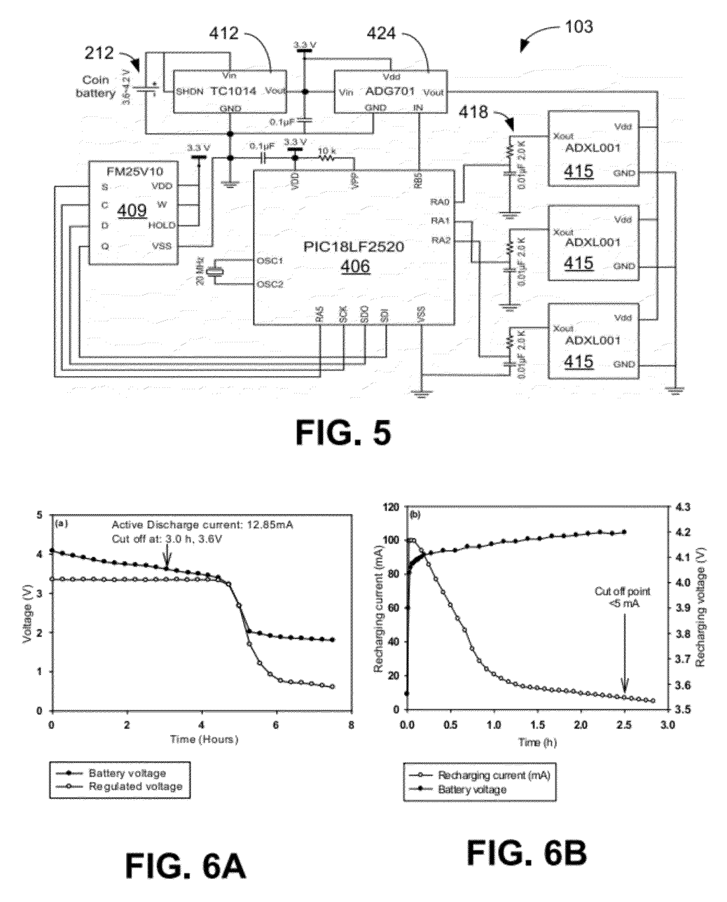

The rechargeable battery 212 of the IR sensor 103 should provide a stable power source with physical dimensions compatible with the main PCB 209. An abundant capacity to keep the IR sensor 103 working fully for three hours or more to ensure valid data collection is also desirable. A 3.7V, 75 mAH Lithium Ion rechargeable coin battery such as, e.g., PD2032 of Korea Power Cell Inc. (Chungnam, Korea) may be used to meet these requirements. The voltage regulator 412 may include a linear low voltage drop (LDO) DC-DC converter (TC1014, Microchip, Chandler, Ariz.) to regulate the battery voltage to 3.3V. The power modes of the IR sensor 103 include a sleep mode, a standby mode, and an active mode to accommodate different working status. In sleep mode, power supplied to three accelerometers 415 is cut off by power switch 424 and the MCU 406 is also in sleep mode. The sleep mode can be used during a recharging period or when the IR sensor 103 is waiting to be used. In the sleep mode, current drain of the whole sensor is limited to about 0.35 mA. The standby mode enables the MCU 406 to establish its communication with the CIU 106 (FIG. 1), while the three accelerometers 415 are powered off, which has a current drain of about 5.6 mA. During the active mode, all components are powered and the IR sensor 103 is in active data recording period. Under the active mode, the maximum current drain is about 12.95 mA. Switching between the power modes is achieved by selectively activating the I/O pins and peripheral circuitry of the MCU 406. FIG. 5 provides a schematic diagram of the electronic circuitry of FIG. 4 to illustrate the connections between the components. For instance, in FIG. 5 the power supplied to the three accelerometers 415 is controlled by an analog power switch 424 such as, e.g., ADG701 (Analog Devices, Norwood, Mass.), which can be toggled by an I/O pin (RB5 in FIG. 5) of the MCU 406.

The battery 212 may be recharged by an external recharger in the CIU 106 (FIG. 1) during testing or downloading of collected data. The discharging and recharging performance of the IR sensor 103 using the PD2032 battery 212 is provided in FIGS. 6A and 6B, respectively. The voltage is about 4.1V when the PD2032 battery 212 is fully recharged. During the active data sampling process, the voltage of the PD2032 battery 212 drops below 3.3V after about 4 hours of stable operation. The battery voltage is regulated to 3.3 V to provide a stable power source for the sensor's components.

Various types of materials may be used for the housing 203 (FIG. 2) IR sensor 103 including, e.g., epoxy resin, silicone rubber (Shore A60), and silicone rubber (Shore A30). Preliminary tests showed that harder molding materials had better performance in keeping data consistent when the IR sensor 103 experiences impacts from different angles. Epoxy resin is one kind of hard material that has been selected by other impact recording devices. However, our preliminary tests showed that the IR sensor 103 was exposed to excessively high impact values when epoxy resin was used due to its hard surface. This could limit the drop height of the IR sensor 103 to a relatively low level to avoid the damage of the IR sensor 103. However, the drop height can reach up to two meters during blueberry mechanical harvest process. For example, with an epoxy resin housing 203 (FIG. 2), the IR sensor 103 may be limited to a 10 cm drop onto a hard surface. Silicone A30 has properties similar to a rubber band, while Silicone A60 is similar to a car tire tread. The silicone rubber with Shore A60 was selected due to its adequate hardness to keep data consistent, to prevent circuitry damage, and to achieve a drop height of about 2 m during the mechanical harvest process.

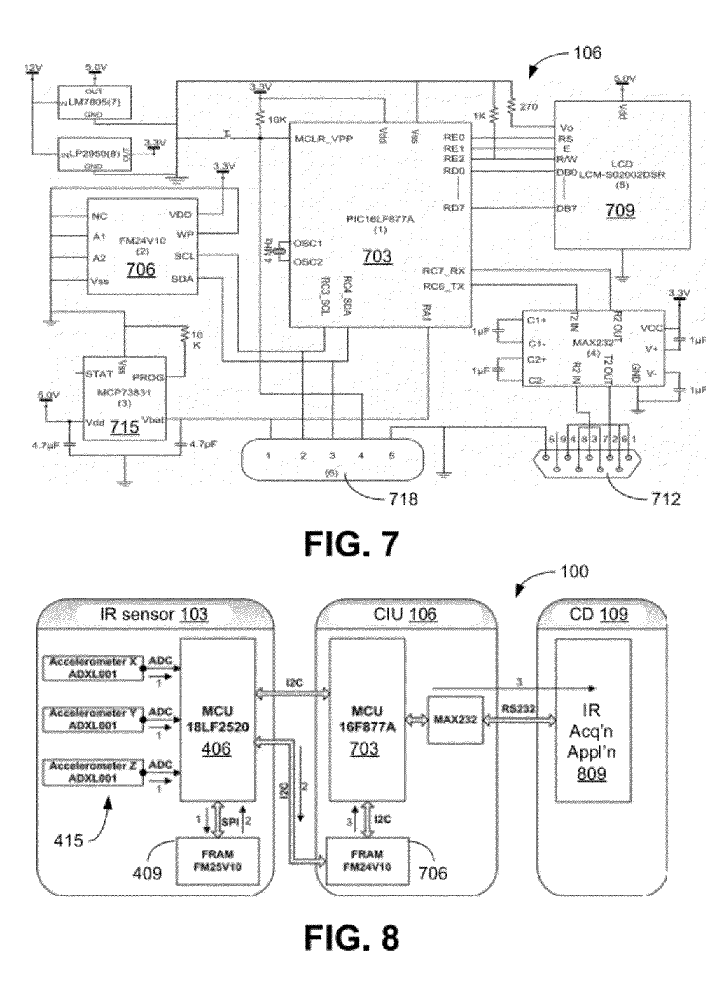

The control interface unit (CIU) 106 of FIG. 1 provides an intermediate device to allow for connection of the IR sensor 103 with the computing device 109 (FIG. 1). Referring to FIG. 7, shown is a schematic diagram of an example of the circuitry of the CIU 106. In the embodiment of FIG. 7, the CIU 106 includes a microcontroller 703 such as, e.g., a PIC16F877 microcontroller by Microchip (Chandler, Ariz.), external memory 706, a liquid crystal display (LCD) 709, RS232 communication port 712, and recharging circuit 715 to recharge the battery 212 (FIG. 2) on the IR sensor 103 through pin 1 of the five-pin connector 718 used for I2C communication with the IR sensor 103. A 12 V power supply to the CIU 106 may be provided by a DC adapter (e.g., 112 of FIG. 1). A parallel liquid crystal display (LCD) 709 is used to display operating status of the IR sensor 103 when connected to the CIU 106. An external F-RAM (I2C) with 1 Mb memory capacity may be used to store data downloaded from the IR sensor 103. The CIU 106 also has switches to control the board power supply to the recharging circuit 715.

The recharging circuit 715 uses, e.g., a MCP73831 chip from Microchip, which provides a recharging voltage of 4.2 V, 100 mA or 500 mA recharging current based on user selection. The recharging chip MCP73831 may be powered by a 9.0V battery or a 9.0V external DC input. To prevent data loss, a low voltage detection function may be realized by sampling the battery voltage periodically through one of I/O pins of the five pin connector 718. A notice of low battery may be provided via the LCD 709 when the battery cut off voltage is reached. Communication between IR sensor 103 and the CIU 106 employs two-wire asynchronous serial communication (I2C) using pins 2 and 3 of the five pin connector 718 while communication between the CIU 106 and the computing device 109 (FIG. 1) uses RS232 protocol using the RS232 connection 712. Pin 4 of the five pin connector 718 can allow for reset of the IR sensor 103.

The IR acquisition application may allow for configuration IR sensor 103, data download, and/or data processing and management. Configuration of the IR sensor 103 includes a user selectable sampling frequency (e.g., 3 kHz) and threshold acceleration, synchronization with the computing device 109 time, and control of power modes (sleep and active). Data can be downloaded from the IR sensor 103 to the CIU 106 and then downloaded to the computing device 109. Data on the F-RAM memory chips 409 (FIG. 5) and 706 (FIG. 7) of both the IR sensor 103 (FIG. 5) and the CIU 106 (FIG. 7) can be erased by sending corresponding commands from the computing device 109. After data downloading, the IR acquisition application can convert the downloaded raw data from digital counts to real acceleration values, save the processed data into, e.g., spreadsheet files, and display the impact data graphically on a display device.

Referring now to FIG. 8, shown is a graphical representation of the data flow between components in the IR system 100. The MCU 406 in the IR sensor 103 samples three channels of analog acceleration signals from accelerometers 415 at, e.g., 3.0 kHz and converts the sampled signals into digital values via the analog to digital conversion of MCU 406. The converted acceleration values that are greater than a user-defined threshold are recorded on the onboard external memory 409 (e.g., F-RAM) via the SPI communication protocol, in order to achieve high sampling frequencies. The IR sensor 103 uploads recorded data to the CIU 106 by writing data into the external memory (F-RAM) 706 via the I2C bus. The microcontroller 703 of the CIU 106 reads the data from the F-RAM 706 via the I2C protocol and sends the data to the computing device 109 through the RS232 cable. The data may then be analyzed using the IR acquisition application 809.

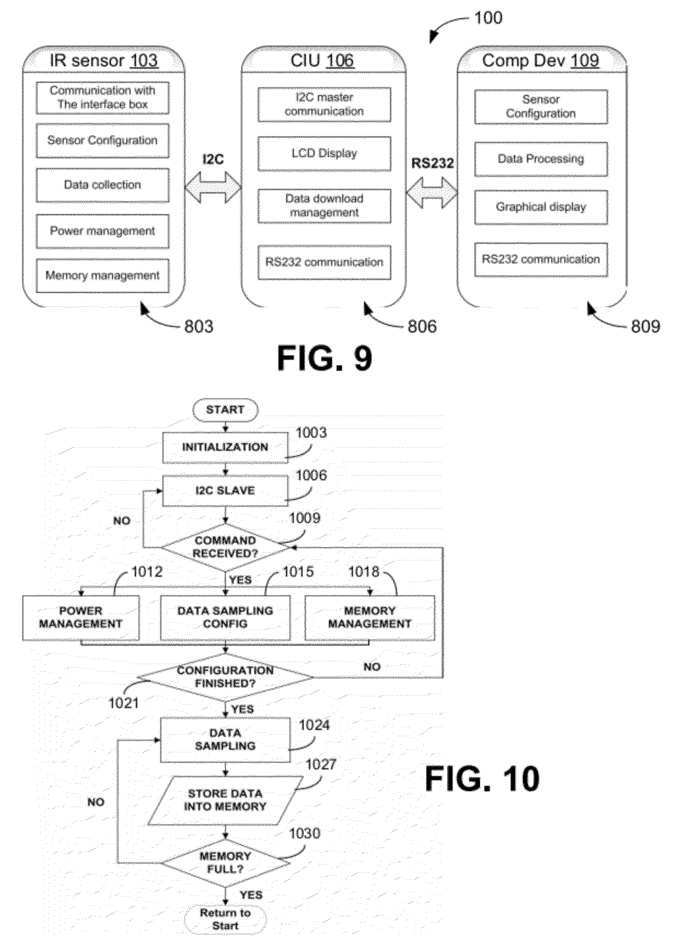

In the example of FIG. 8, the IR system 100 includes a sensor application or program 803 (FIG. 9) that is executed by the MCU 406 of the IR sensor 103, an interface application or program 803 (FIG. 9) that is executed by the microcontroller 703 of the CIU 106, and the IR acquisition application or program 809 that is executed by the computing device 109. The IR acquisition application 809 includes a graphical user interface (GUI). A PIC Basic Pro compiler (PBP, Micro Engineering Labs, Colorado Springs, Colo.) may be used for program development for microcontrollers 406 and 703 on the IR sensor 103 and the CIU 106, respectively. For example, sensor application 803 codes were programmed into the MCU 406 and microprocessor 703 via an in circuit serial programmer (ICSP programmer, Micro Engineering labs, Colorado). The IR acquisition application 809 on the computing device 109 was designed in the LabVIEW 8.2 environment (National Instruments, Austin, Tex.).

Examples of functions implemented by the sensor application 803, the interface application 806, and the IR acquisition application 809 are shown in FIG. 9. The IR sensor application 803 includes, e.g., sensor configuration, impact data collection (or sampling), and/or data (or memory) management. The sensor application 803 may be stored in a portion of the external memory 409. Referring to FIG. 10, shown is a flow chart illustrating an example of the sensor application 803. Configuration of the IR sensor 103 is processed based upon commands received from the microcontroller 703 of the CIU 106, when the MCU 406 of the IR sensor 103 works in I2C slave mode. By executing each command, the sensor application 803 enters into a corresponding subroutine, which carries out the specific function.

Beginning with box 1003, initialization of the IR sensor 103 is performed. First, a master synchronous serial port (MSSP) module is configured into I2C mode to communicate with the microcontroller 703 and the external memory 706 of the CIU 106 (FIG. 8). The MSSP module is also configured to hardware SPI module to communicate with external memory 409 of IR sensor 103 (FIG. 8). An USART is also setup to establish an RS232 communication protocol. The MCU 406 works at 5 MIPS based on a 20 MHz resonator frequency. A Timer2 module may be employed to create an interrupt service routine (ISR) for the real time clock (RTC) of the IR sensor 103.

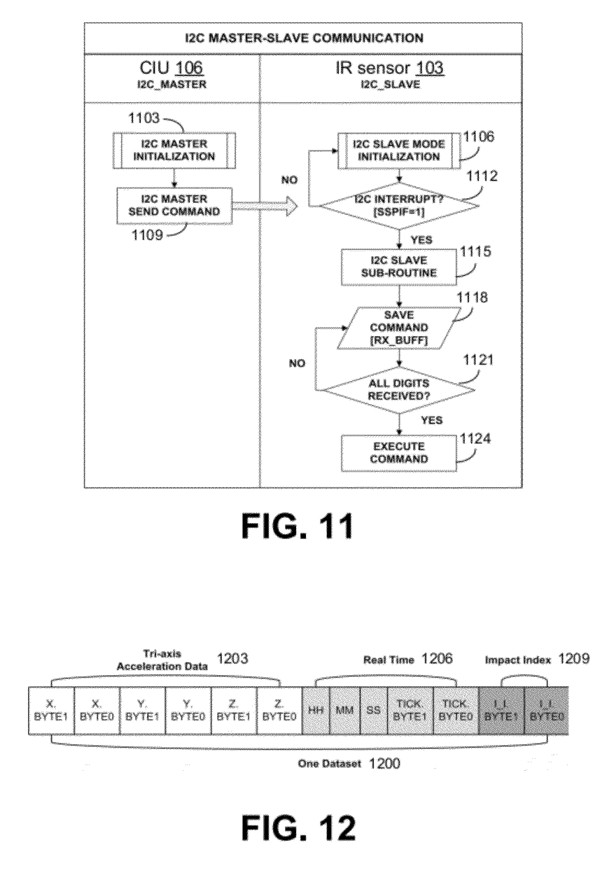

In box 1006, the IR sensor 103 enters an I2C slave mode of operation and waits for the arrival of commands from the microcontroller 703 of the CIU 106 in box 1009. The IR sensor 103 may be configured based upon user selections through the GUI of computing device 109. The IR sensor 103 is configured by receiving commands that are sent out from the computing device 109 and transmitted by the microcontroller 703 of the CIU 106. The communication between the two MCUs 406 and 703 of the IR sensor 103 and the CIU 106 employs the I2C protocol, as illustrated in the flow chart of FIG. 11. Initially, the CIU 106 preforms the I2C master initialization (box 1103) and the IR sensor 103 preforms the I2C slave mode initialization (box 1106). The microcontroller 703 of the CIU 106 (I2C Master) sends control commands (box 1109) to the MCU 406 of the IR sensor 103 in a predefined format. For example, each command can comprise 10 digits, with the first 9 digits containing the command information and the last digit determining the command type. When the IR sensor 103 detects an I2C interrupt (box 1112), the IR sensor 103 initiates an I2C slave subroutine (box 1115). The IR sensor 103 saves the command in the receive buffer (box 1118) unit all digits have been received (box 1121). At that time, the IR sensor 103 executes the command (box 1124).

Referring back to box 1009 of FIG. 10, the MCU 406 of the IR sensor 103 executes each command received from the CIU 106. Commands can be used for power management (box 1012) such as, e.g., setting up different power modes (e.g., sleep, standby, and active modes), for sampling configuration (box 1015) such as, e.g., setting a sensor sampling threshold, sampling frequency, and/or sensor clock synchronization with the computer clock, or for memory management (box 1018). For example, the acceleration sampling threshold may be selected from a plurality of predefined options (e.g., 0 g, 18 g, 24 g, 41 g, 53 g, 99 g, and 205 g), which covers from the low g level to medium g level. This range provides enough options for filtering impacts at different levels that are used in the field. The sampling frequency may also be selected from a set of predefined options (e.g., 682 Hz, 998 Hz, 1480 Hz, 2210 Hz, and 3050 Hz). This sampling frequency range allows the IR sensor 103 to record impacts the sensor experiences. Clock synchronization can be achieved by updating the timer of the MCU 406 of the IR sensor 103 upon receiving real-time information from the computing device 109.

Sets of acceleration data are saved into the memory in a predefined format such as the example of FIG. 12. Each dataset 1200 has 13 bytes including the tri-axis acceleration data 1203 from the x-axis, y-axis, and z-axis accelerometers 415 (FIG. 8), the real time 1206, and the impact index 1209. Each axis of accelerometer data 1203 uses two bytes due to 10 bits of A/D conversion resolution. The time each impact occurred is recorded in order to characterize the mechanical harvest process. To provide adequate timer accuracy for a maximum sampling frequency of 3.0 KHz, the resolution of the timer should be at least 1/3000 of a second. The clock of the IR sensor 103 was created with a resolution of 0.25 ms (TICK), using the interrupt service routine (ISR) based on the Timer2 module that provided by the PIC18LF2520 MCU 406. The second is updated when the TICK equals to 4000. The hour (HH), minute (MM), and second (SS) occupy one byte each, while the TICK uses two bytes. The impact index 1209 can count datasets up to 65536 with two bytes, which is adequate for a typical field test.

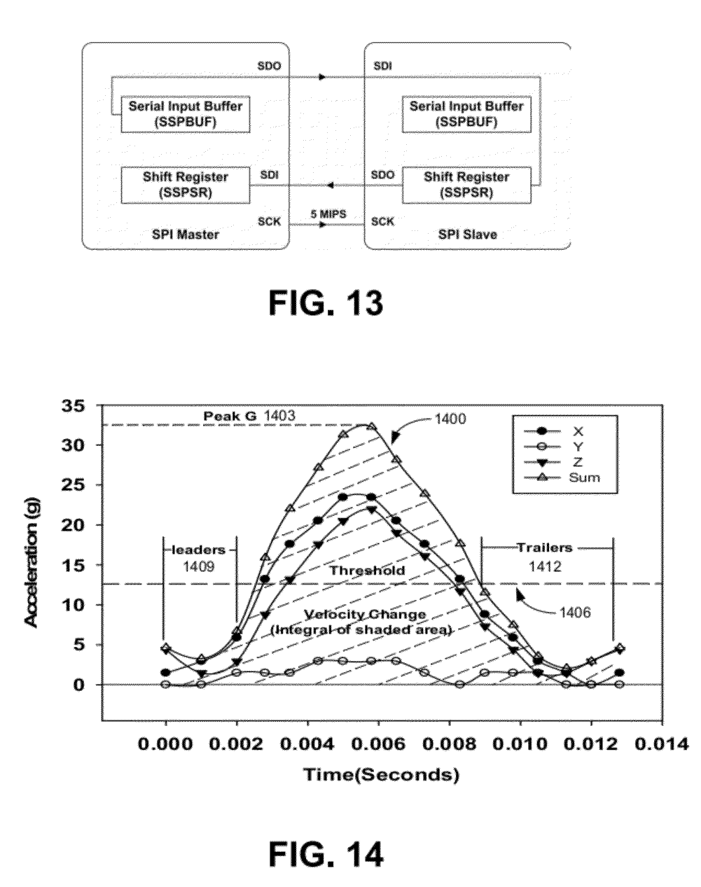

Datasets are managed using four subroutines which can perform write, read, erase and upload. Datasets are written into the external (F-RAM) memory 409 (FIG. 8) using the hardware SPI protocol as illustrated in FIG. 13. The SPI module transfers the data serially with one byte each time. The thirteen bytes (one dataset) are serially written into sixteen bytes of memory, leaving the last three bytes empty. The reason is the MCU 406 may have address handling errors if the address is increasing continuously. During the data downloading process, the MCU 406 on the IR sensor 103 reads data from the external F-RAM memory 409 (using SPI communication) on the IR sensor 103 and writes the data into the F-RAM memory 706 (using I2C communication) on the CIU 106 (FIG. 8). Both the I2C and SPI communication protocols are established based on the MSSP module, so the MCU 406 forces the MSSP module to either I2C or SPI mode before it communicates with the respective memory 409 or 706. Two subroutines were created to setup the MCU 406 to either I2C or SPI mode. The appropriate subroutine is called when the corresponding mode is selected. The SPI module writes data based on the bus speed of the MCU 406 (e.g., 5 MIPS), which ensures the MCU 406 can record data in a fast pace 1.5 ms/impact) during the data sampling cycle. The external memory (F-RAM) 409 may also be erased with one command.

Referring back to box 1021 of FIG. 10, when the configuration of the IR sensor 103 is finished, the data sampling may begin in box 1024 based upon the configuration of the IR sensor 103. The IR sensor 103 records data based on the actual impacts it experiences. In box 1027, impact data is stored in external memory 409 in response to a sensed impact. For example, a series of impact datasets obtained about the sensed impact are stored for later retrieval. If the external memory 409 is not full in box 1030, then the flow returns to box 1024 to continue data sampling and monitoring for the next impact. Otherwise, the data acquisition ends.

If sampled at a sufficiently high frequency, each impact can be depicted as a bell shape curve 1400 with a certain time of duration as illustrated in FIG. 14. A vector summation is calculated based on the tri-axis acceleration data 1203 (FIG. 12):

Sum=\sqrt{X²+Y²+Z²}; (1)

where the peak G 1403 is the maximum value of the vector summation. The area under the bell curve 1400, calculated by the integration of the impact curve with impact duration, is defined as the velocity change. The velocity change is another important index to define an impact's aggressiveness. The threshold acceleration 1406 is selected to record impacts that are higher than the threshold 1406 in order to avoid recording minor impacts which may fill the memory quickly. In order to record the whole shape of the impact to more accurately calculate the velocity change, certain data points under the threshold are also recorded: e.g., three data sets before the impact data and six after the impact curve, defined as leaders 1409 and trailers 1412, respectively. The three sections of acceleration data (leaders 1409, impacts data above the threshold 1406, and trailers 1412) are recorded into different arrays but belong to the same impact. A LT_F flag is used to sort out impacts points that may belong to any of the three sections.

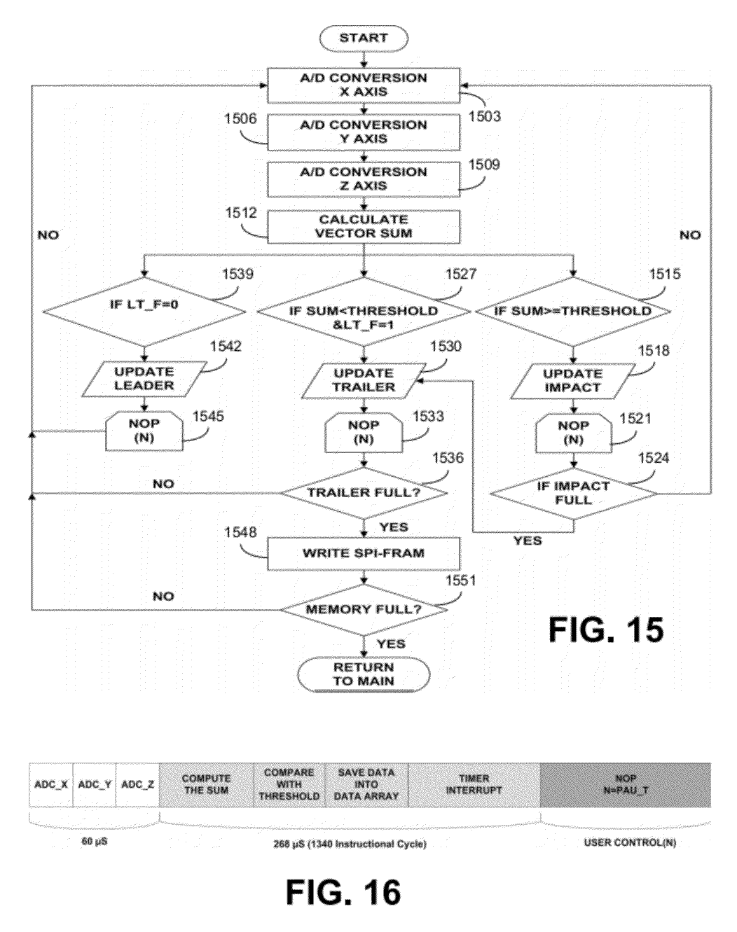

Referring to FIG. 15, shown is a flow chart illustrating an example of a whole sampling cycle (boxes 1024-1030 of FIG. 10) for recording a complete impact. Data sampling begins with A/D conversion of the x-axis (box 1503), y-axis (box 1506), and z-axis (box 1509) analog accelerometer voltages into digital values. After conversion of the tri-axis analog signals into digital values, the scalar value of the vector sum is calculated in box 1512 following equation 1. The vector sum is compared to the user selected threshold value 1406 (FIG. 14). If the peak of the impact data is greater than or equal to the threshold 1406 in box 1515, then the LT_F flag is set to one indicating that an impact has been sensed and the impact array will be updated with the impact data with a peak G higher than the threshold 1406 in box 1518. As the threshold value 1406 has a resolution of 5.86 g/count, this may allow the IR sensor 103 to record impacts with peak G slightly lower than the threshold 1406. Void operations (NOP) are carried out in box 1521 to idle the system clock for a defined number of instructional cycles to delay the sampling process for lower sampling frequencies. If the impact array is not full in box 1524, the flow returns to box 1503 to obtain the next set of data.

If the peak of the impact data is less than the threshold 1406 in box 1527, but the LT_F flag=1 indicating that an impulse has been detected, then the trailer array is updated in box 1527 and void operations (NOP) are carried out in box 1533. If the trailer array is not full in box 1536, the flow returns to box 1503 to obtain the next set of data. If the LT_F flag is set to zero in box 1539 indicating that no impact has been detected, then the leader array is updated in box 1542 and void operations (NOP) are carried out in box 1545 before the flow returns to box 1503 to obtain the next set of data. The leader array records at least the three most recent datasets. The leader count may be monitored using, e.g., a L_C counter.

If the impact array is full in box 1524, then the trailer array is updated in box 1530 and void operations (NOP) are carried out in box 1533. This will avoid loss of impact data. If the trailer array is full in box 1536, then the recorded datasets for the leaders 1409, impacts, and trailers 1413 are written to external memory 409 in box 1548. If the memory 409 is not full in box 1551, then the flow returns to box 1503 to obtain the next set of data. Otherwise, the data acquisition ends.

The total sampling cycle which records the leaders 1409 (FIG. 14), impact data above the threshold 1406, and the trailers 1412 (FIG. 14) determines the maximum sampling frequency, which can be up to 3.0 KHz. FIG. 16 illustrates an example of the breakdown analysis for the time used to record one dataset. The AD conversion of the tri-axis acceleration values takes 60 μsec in total, as defined by the AD conversion procedure (boxes 1503-1509) in the MCU 406. It takes 268 μsec for calculation (box 1512) and comparison (boxes 1515, 1527, 1539) of the vector summation values, array update (boxes 1518, 1530, 1542), and the timer interrupt (boxes 1521, 1533, 1545), determined by instructional cycles of each command. The void operations (NOP), which idle the system clock for given number of instructional cycles, are used to delay the sampling process for creating lower sampling frequencies. The sampling cycle length can be adjusted by changing the number (N) of void operations (NOP) with the maximum frequency of 3.0 KHz, when N equals to 0 (no delay). Four other lower frequency options (e.g., 682 Hz, 998 Hz, 1480 Hz, and 2210 Hz) were created using the method and verified by calculating the number of data points sampled within a known duration of time.

Referring back to FIG. 9, the interface application 806 establishes communication between the IR sensor 103 and the computing device 109. It transfers the control commands from computing device 109 to the IR sensor 103, uploads data from the IR sensor 103 to the computing device 109, and updates the information on the LCD display. The interface application 806 executed by the microcontroller 703 (FIG. 8) of the CIU 106 also monitors the battery level of the IR sensor 103 by sampling an A/D channel connected with the sensor battery 212 (FIG. 2). The microcontroller 703 on the CIU 106 works in the I2C master mode when communicating with the IR sensor 103. It receives commands and sends data to the computing device 109 via the RS232 serial communication. The CIU 106 recharges the battery 212 in the IR sensor 103 when the battery voltage drops below a cutoff voltage (e.g., 3.6 V). In some implementations, a user may turn on a switch for recharging the battery 212 of the IR sensor 103.

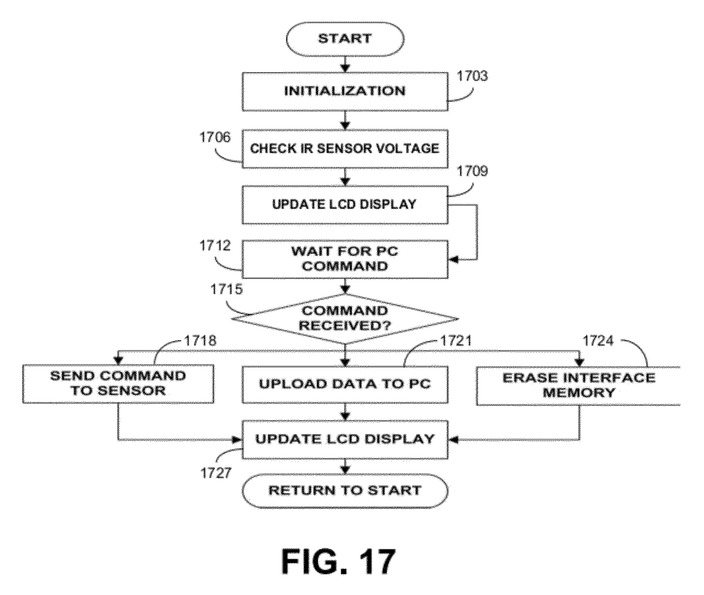

Referring to FIG. 17, shown is a flow chart illustrating an example of the interface application 806. Beginning with box 1703, initialization of the CIU 106 is carried out. In box 1706, the voltage of the battery 212 (FIG. 2) of the IR sensor 103 is checked. The CIU 106 may begin charging the battery 212 based upon the detected voltage level. The LCD display 709 may then be updated in box 1709 and the CIU 106 waits for commands from the computing device 109 in box 1715.

When the interface application 806 receives commands from the computing device 109, the interface application 806 executes that command's request. A plurality of commands may sent by the computing device 109. For example, the commands may include, e.g., commands (e.g., power mode) that are sent to the IR sensor (box 1718), a command to upload data from the memory 706 of the CIU 106 (box 1721), and/or a command to erase the memory 706 of the CIU 106 (box 1724). Commands about sensor configuration are passed down to the IR sensor 103 via the I2C bus in box 1718. Other commands for CIU 106 management are executed for the data management in the CIU 106. Data may be retrieved from the memory 409 of the IR sensor 103 via I2C communication and uploaded to the computing device 109 via the RS232 communication. The memory 706 of the CIU 106 can be erased after data are uploaded. The LDC display may then be appropriately updated in box 1727.

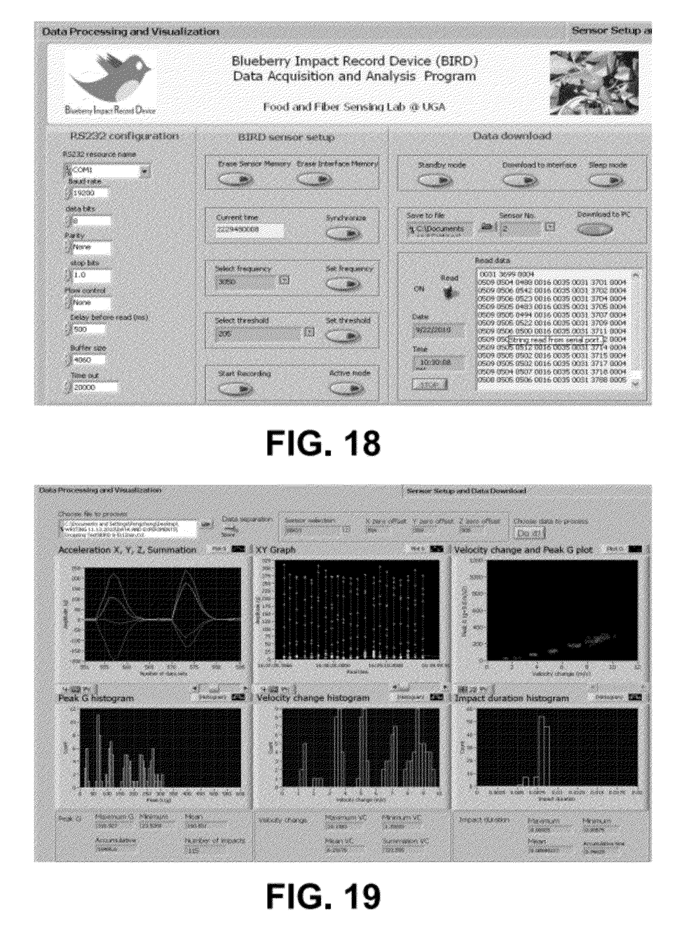

Referring back to FIG. 9, the IR acquisition application 809 is configured to communicate with the IR sensor 103 via the CIU 106, process and display recorded data, and/or provide data reports through one or more graphical user interfaces (GUIs). In some embodiments, the computing device 109 may include the CIU 106. For example, FIG. 18 illustrates an example of a “Communication and Data Download” interface. The “Communication and Data Download” interface of FIG. 18 includes three sections: a RS232 configuration section for serial communication setup between the computing device 109 and the CIU 106, an IR sensor setup section for configuration of the IR sensor 103, and a data download section for downloading and saving data. Users can setup the RS232 communication through, e.g., the VISA control in the LabVIEW. To setup the IR sensor 103, users may erase both the external memory 409 of the IR sensor 103 and the memory 706 of the CIU 106, and then synchronize the time between the computing device 109 and the IR sensor 103. Different sampling frequencies and threshold values may be selected based on users' needs. The power mode is switched to “active” mode to enable the power supply to all components before starting data recording.

The GUI may also be used to manage the data download processing from the IR sensor 103. The power mode can be switched to the “standby” mode in order to save the power of the battery. Data are first downloaded from the IR sensor 103 to the CIU 106 before being transferred to the computing device 109 and saved as, e.g., ASCII files. A header file, which includes the synchronization time, sampling frequency and threshold, sensor number, and the file path, will be automatically generated when the data downloads occurs. Downloaded data may then be viewed through a “Read data” window in real time.

A data processing GUI is shown in FIG. 19, which processes the raw data and saves the processed data into spreadsheets or other file format. The data being processed may be rendered and graphically displayed for users' quick diagnosis and evaluation of the data. The three graphs in the first row illustrate the data from three aspects:

The top, left plot includes raw acceleration data without time. Impact data from the tri-axis accelerometers 415 (FIG. 4) and their vector summations are plotted in the first graph. This display helps to interpret what are the raw acceleration values recorded on each axis and the shape of each impact curve without time information. It also aids in locating each single data point based on the impact index. For instance, it can track acceleration values generated by the high speed spinning of the IR sensor 103, which are not actual dynamic impacts.

The top, center plot includes acceleration data with time. The second graph shows the impact curves against time. Each sampling point is a summation of the three axis values with the exact time provided by the clock on the IR sensor 103. The distribution of all single impacts can be identified. From the overall view, groups of impacts can be identified and separated with time information, corresponding to actual impact events recorded by the user. By zooming in this display, the real impact curve shape can be viewed, the impact duration, and peak-G value can be accessed. During the field test operation, it can also be used to identify experimental replicates, or eliminate irrelative impacts.

The top, right plot includes peak G against velocity change graph. The program integrates the area under each impact curve as the velocity change, the velocity change of each impact curve and its corresponding peak G value are plotted in one graph. Locations of impacts on this graph indicate their intensity which can be used to predicate the probability of creating the bruising.

The three graphs in the second row show histograms of Peak G (bottom, left), velocity change (bottom, center), and the duration of each impact (bottom, right). Descriptive statistical results of these parameters are also calculated and displayed below each display.

The real time clock was created by using the interrupt service routine and Timer2 module of the MCU 406 (PIC18LF2520). Error can be introduced from both the software and the resonator (CSTCE20MOV53Z-R0, Murata Electronics, Kyoto, Japan). The resonator has initial frequency error of 0.5%. Temperature drifting can also introduce error into the resonator speed, with 0.15% temperature stability within the range of −40 to 120° C. Therefore, the PIC18LF2520 software timer was tested and calibrated to ensure its best performance.

The IR sensor 103 was mounted on an impact table with the z-axis being the sensing axis along the impact direction (up and down). The impact table has two vertically mounted sliding tracks. The impact board can be released from a given height to impact with the base. Acceleration values sampled from the z-axis were recorded by both the IR sensor 103 and a NI-DAQ data logger (NI-6008, National Instruments, and Austin, Tex.). The NI-DAQ data logger has higher sampling frequency and accuracy (11 bits input resolution and 14.7 mV absolute accuracy) and therefore was used to compare with the data collected from the IR sensor 103. A LabVIEW Signal Express program (Signal Express 3.0, National Instruments, and Austin, Tex.) was used to setup the NI-DAQ data logger with a 10 kHz sampling frequency using a referenced single ended (RSE) signal mode. The computer time that NI-DAQ recorded was regarded as the standard time (resolution: 41.67 ns).

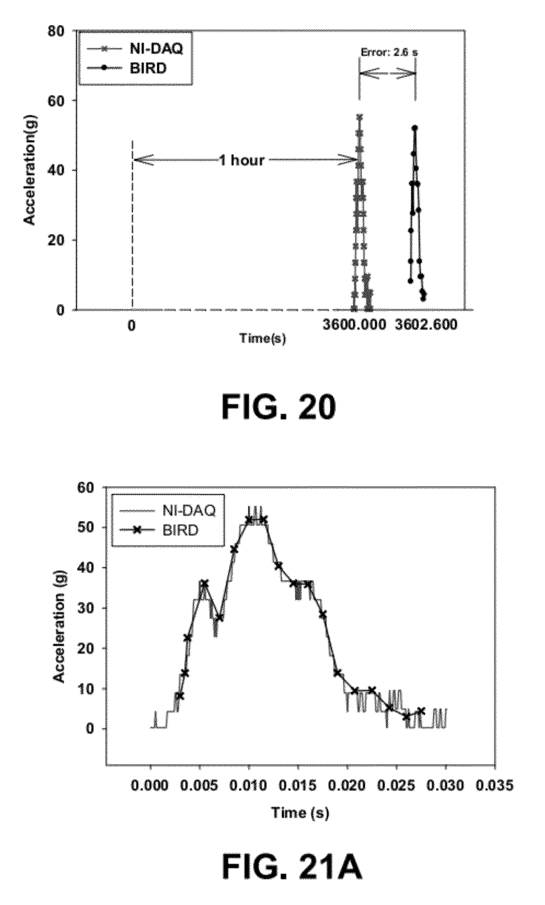

Referring to FIG. 20, shown is a plot illustrating the IR sensor clock error calibration based upon dynamic impacts. To calibrate the timer of the IR sensor 103, the IR sensor 103 is synchronized with the computer time at time 0; the impact board was released every five minutes to generate impacts, which were recorded by both the NI-DAQ and the IR sensor 103. For the same impact, the difference between the computer clock and the IR sensor 103 clock was regarded as the error of the IR sensor 103 clock. The clock error of the sensor was calibrated at one hour, as the IR sensor 103 clock usually can be synchronized again within one hour in the field.

The minimum interrupt duration of the IR sensor 103 was designed to be 0.25 ms (TICK). Therefore, the second should be updated every 4000 TICKS theoretically, the minute should be updated every 60 seconds, and the hour updated every 60 minutes. The calibration was replicated three times to calculate the average error of the timer. The TICK was adjusted to 3998 after calibration, with the average error of 0.073%, which equals an error of about 2.6 seconds error in a whole hour.

The sampling frequency of the IR sensor 103 can be confirmed by checking the number of data points recorded within certain duration of time. Five frequencies were confirmed using this method: 682 Hz, 998 Hz, 1480 Hz, 2210 Hz, and 3050 Hz. The maximum sampling frequency is 3050 Hz.

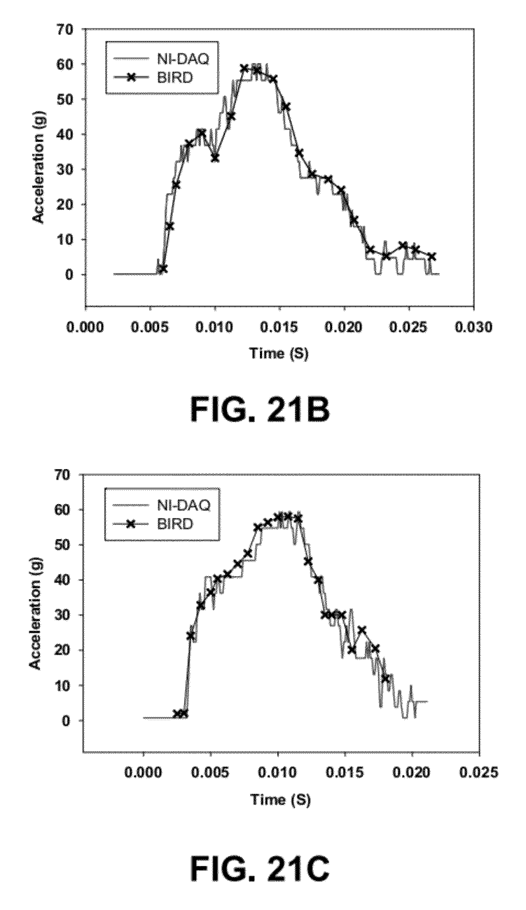

To evaluate the distortion of the recorded impact curve, the sample impact curve recorded by the IR sensor 103 may be evaluated. The experimental setup used for the clock error calibration was also used to generate dynamic impacts, the signal response of the accelerometers were both sampled by IR sensor 103 and the NI-DAQ. Three lower frequencies of the IR sensor 103 (i.e., 682 Hz, 998 Hz and 1480 Hz) were selected to record the impacts, with the measurements replicated ten times for each frequency, since higher sampling frequency can record impacts with better accuracy. The impact curve shape recorded by IR sensor 103 and the NI-DAQ matched well with each other in all ten replicates for the three selected sampling frequencies. FIGS. 21A, 21B, and 21C show typical impact curves among the 10 replications for each frequency 668 Hz, 998 Hz, and 1480 Hz, respectively. The sensor application can record exactly about the impact, in aspects of impact duration, acceleration values and curve detail. The velocity change was also calculated, with relative errors of 0.8%, 4.4% and 2.1%, respectively. Since error of velocity change depends on G values and timer accuracy, the reported three velocity change errors fall within an acceptable range of <5%. The duration of impact can be calculated through the number of impact points divided by the sampling frequency. Increasing sampling frequency will reduce the allowable maximum duration of a complete impact curve. The impact curves at 668 Hz, 998 Hz, and 1480 Hz illustrated in FIGS. 21A, 21B, and 21C, respectively have durations of about 20 ms, which is much longer than the IR sensor 103 experiences in the field (typically about 6 ms).

The SPI bus for the external memory 409 of the IR sensor 103 (FIG. 8) also uses the same bus speed (5 MIPS) as the MCU 406 (FIG. 8). The I2C communication between the IR sensor 103 and CIU 106 (FIG. 8) uses I2C master slave mode, which transmits data at a 400 kHz bus speed. Communication between CIU 106 and the computing device 109 and the IR acquisition application 809 (FIG. 8) uses RS232 at a baud rate of 19200. To evaluate the IR system's 100 speed performance to guide through the field process or application, each operation procedure was clocked to test its performance. Tests of erasing IR sensor 103 memory 409, uploading IR sensor 103 data to the CIU 106 and uploading IR sensor 103 data to the computing device 109 relied on the CIU 106 LCD 709 (FIG. 7) to indicate the start and finish of that operation. Writing an impact array to the SPI memory 409 on the IR sensor 103 was estimated based on the programming commands used. The speed for erasing IR sensor 103 memory 409 is much faster (about 6 sec) than uploading IR sensor 103 data to CIU 106 (about 35 sec) and uploading data to the computing device 109 (about 68 sec) since only the SPI protocol is used in uploading data to the CIU 106. The I2C and RS232 communication set bottle necks for the overall data download processes, however, those times may not be significant during field operation, based on the IR sensor's 103 battery performance (3 hours) and memory size (about 500 impacts), which usually requires half hour between downloads. Writing an impact array into SPI memory 409 took about 0.015 sec.

The IR sensor 103 was calibrated using a centrifuge (EPPENDORF 5810, Hamburg, Germany) following ANSI/ISA, 1979 (Wheeler and Ganji 1996). The principle of using a centrifuge for calibration is that it can provide accurate and stable acceleration at the centripetal direction at a given rotation speed. If the distance between a certain point (the sensor in this case) to the pivot of the centrifuge is known, the acceleration at that point can be calculated by the following equation:

$$G = {( \frac{RFM \times 2 π}{60} )}^{2} \times r \\ ( \frac{{m}^{2}}{s} ) ; \qquad ( 2 )$$

The mounting orientation of the IR sensor 103 was not purposely controlled in each test because the vector summation of acceleration values from three axes instead of from single axis was calibrated.

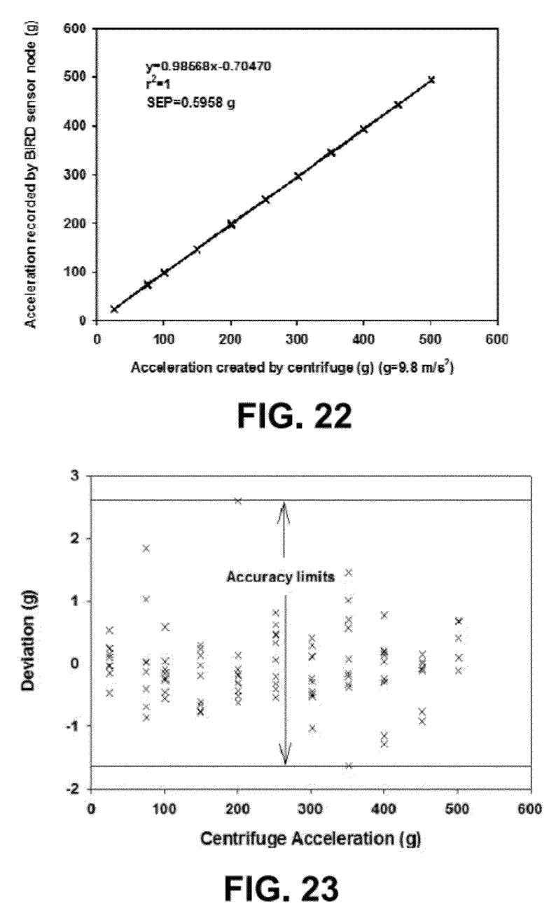

Eleven rotational speeds of the centrifuge were selected from 440 to 1960 rotations per minute (RPM), corresponding to centripetal acceleration values from 25.28 to 501.67 g (g=9.80 m/s²). This range is adequate to calibrate our accelerometers which have the dynamic range of ±500 g. The centrifuge was started at lowest speed level, stepped up to the highest speed, and then gradually slowed down to the lowest speed. This up and down cycle was repeated six times. In order to avoid the error that could be potentially created at the starting and ending period of the centrifuge, the first five acceleration values of the first cycle and the last sixteen accelerations of the sixth cycle were not used, to make five complete cycles. Due to the up and down cycles, there were ten replications for each of the 11 acceleration values except for the maximum acceleration value 501.67 g which was only replicated five times. Those data were used for a linear regression analysis between the acceleration values created by the centrifuge and recorded by the IR sensor 103. As illustrated in FIG. 22, an extreme linear relationship between the centrifuge and IR sensor 103 was observed with a coefficient of correlation (r²) of one and standard error of prediction of 0.5958 g. Given the sensing range of 500 g from each accelerometer, the error was minimal.

To further evaluate the accuracy of the IR sensor 103 data, the difference between the measured values by the IR sensor 103 and the values calculated by the best-fit equation was analyzed. As shown in FIG. 23, the accuracy limit, which is the range of deviation from both the up and down cycles, is from −2.60 g to 1.62 g in the test. Given an input range of 0 to 500 g, the output span of the prediction line is from −0.7 g to 492.2 g, produces a span of 492.9 g. The accuracy becomes −0.53% and 0.33% of the output span.

The repeatability error, which is also the estimated precision uncertainty, can be evaluated from the maximum variability of successive measurements of the same value input. The maximum value was found to be 3.11 g, corresponding to a precision uncertainty of 0.63% in the prediction range. The hysteresis error was evaluated as the maximum difference between the “up” cycle and the “down” cycle for the same input value in any of the calibration cycles. The maximum difference is found to be 3.21 g and occurred at 200.79 g, which corresponds to 0.65% of the output span of the predicated line.

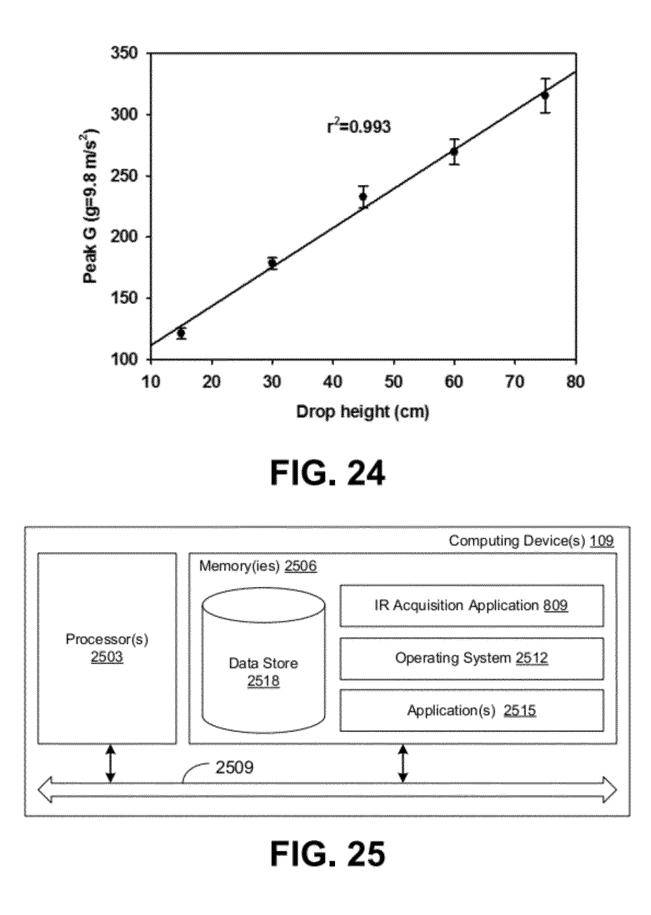

The performance of the IR sensor 103 under a situation with dynamic impacts was also verified. For this purpose, the IR sensor 103 was tested using an impact table. When the impact board was released at a given height (distance between the impact point and the base) and collided with the hard wood base, an impact was created and recorded by the IR sensor 103 mounted on the impact board. The impact board was released at five different drop heights (15 cm, 30 cm, 45 cm, 60 cm, and 75 cm) with 20 replications for each drop height. Each drop created multiple impact values (including rebounds), but only the maximum impact values were evaluated for each drop. As shown in FIG. 24, the peak G recorded can increase along with drop height with outstanding linear relationship (r²>0.98). The standard deviations were 4.57, 4.54, 9.07, 10.23, and 13.83 for the five drop heights from 15 cm to 75 cm, respectively. Variation can also come from the impact table's release heights, the consistency from impact material's contact with the base. Considering all the error sources, the IR sensor 103 maintained good consistency throughout the test.

With reference to FIG. 25, shown is a schematic block diagram of a computing device 109 according to an embodiment of the present disclosure. The computing device 109 includes at least one processor circuit, for example, having a processor 2503 and a memory 2506, both of which are coupled to a local interface 2509. To this end, the computing device 109 may comprise, for example, at least one server computer or like device. The local interface 2509 may comprise, for example, a data bus with an accompanying address/control bus or other bus structure as can be appreciated.

Stored in the memory 2506 are both data and several components that are executable by the processor 2503. In particular, stored in the memory 2506 and executable by the processor 2503 are the IR acquisition application 809, operating system 2512, and other applications 2515 as can be appreciated. Also stored in the memory 2506 may be a data store 2518 and other data. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 2506 and are executable by the processor 2503. In this respect, the term “executable” means a program file that is in a form that can ultimately be run by the processor 2503. Examples of executable programs may be, for example, a compiled program that can be translated into machine code in a format that can be loaded into a random access portion of the memory 2506 and run by the processor 2503, source code that may be expressed in proper format such as object code that is capable of being loaded into a random access portion of the memory 2506 and executed by the processor 2503, or source code that may be interpreted by another executable program to generate instructions in a random access portion of the memory 2506 to be executed by the processor 2503, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Similarly, the IR sensor 103 and CIU 106 include at least one microcontroller (406 and 703, respectively) or processor and memory, which may be internal or external to the microcontroller. A local interface includes, for example, a data bus with an accompanying address/control bus or other bus structure for communication between components of the IR sensor 103 and CIU 106 as can be appreciated. Stored in the memory are data and/or several components that are executable by the microcontroller (406 and 703, respectively) or processor. In particular, stored in the memory and executable by the microcontroller 406 of the IR sensor 103 is the sensor application 803. Similarly, stored in the memory and executable by the microcontroller 703 of the CIU 106 is the interface application 806.

The memory is defined herein as including both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Although the sensor application 803, the interface application 806, and the IR acquisition application 809, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

FIGS. 8-11, 15, 17, and 19 illustrate examples of functionality and operation of an implementation of portions of the sensor application 803, the interface application 806, and the IR acquisition application 809. If embodied in software, each box of the flow charts may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a microcontroller or processor in a computer system or other system. The machine code may be converted from the source code, etc. If embodied in hardware, each box of the flow charts may represent a circuit or a number of interconnected circuits to implement the specified logical function(s).

Although the flowcharts of FIGS. 10-11, 15, and 17 show a specific order of execution, it is understood that the order of execution may differ from that which is depicted. For example, the order of execution of two or more blocks may be scrambled relative to the order shown. Also, two or more blocks shown in succession in FIGS. 10-11, 15, and 17 may be executed concurrently or with partial concurrence. Further, in some embodiments, one or more of the blocks shown in FIGS. 10-11, 15, and 17 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the sensor application 803, the interface application 806, and the IR acquisition application 809, that comprises software or code can be embodied in any non-transitory computer-readable medium for use by or in connection with an instruction execution system such as, for example, a microcontroller or a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. An impact recording sensor, comprising:
an impulse sensing system configured to sense impacts experienced by the impact recording sensor in three dimensions;
a microcontroller unit (MCU) configured to obtain impact data from the impulse sensing system and store an impact data set including the impact data in memory in response to an impact experienced by the impact recording sensor; and
a rechargeable power source configured to supply power to the MCU.

2. The impact recording sensor of claim 1, further comprising a spherical housing encasing the impulse sensing system, the MCU, the memory, and the rechargeable power source.

3. The impact recording sensor of claim 2, wherein the spherical housing has a diameter of about one inch or less.

4. The impact recording sensor of claim 2, wherein the spherical housing comprises silicon rubber.

5. The impact recording sensor of claim 1, wherein the impulse sensing system comprises three single-axis accelerometers, where two of the single-axis accelerometers are mounted on a main circuit board to sense impacts along an x-axis and a y-axis and the third single-axis accelerometer is mounted on a secondary circuit board mounted substantially perpendicular to the main circuit board to sense impacts along a z-axis.

6. The impact recording sensor of claim 5, wherein the rechargeable power source is mounted in parallel with the main circuit board on a side opposite the secondary circuit board.

7. The impact recording sensor of claim 1, further comprising a connector configured to communicatively couple the MCU with a control interface unit.

8. The impact recording sensor of claim 7, wherein connector is further configured to couple a recharging unit with the rechargeable power source.

9. The impact recording sensor of claim 1, wherein the MCU includes a plurality of analog-to-digital converters (ADC) to obtain impact data from the impulse sensing system.

10. The impact recording sensor of claim 1, wherein the MCU is configured to:
obtain impact data from the impulse sensing system at a sampling time;
compare the impact data at the sampling time to a predefined threshold; and
store an impact data set including the impact data at the sampling time in the memory in response to the comparison with the predefined threshold.

11. The impact recording sensor of claim 10, wherein impact data is obtained from the impulse sensing system at a predefined sampling frequency.

12. The impact recording sensor of claim 11, wherein a plurality of impact data sets corresponding to a series of sampling times is stored in response to the impact data exceeding the predefined threshold.

13. The impact recording sensor of claim 12, wherein the plurality of impact data sets includes impact data sets corresponding to a predefined number of sampling times preceding the sample time where the impact data exceeds the predefined threshold and a plurality of impact data sets corresponding to a plurality of sampling times following the sample time where the impact data exceeds the predefined threshold.

14. The impact recording sensor of claim 10, wherein comparing the impact data to a predefined threshold includes determining a vector sum of the impact data and comparing the vector sum to the predefined threshold.

15. The impact recording sensor of claim 10, wherein the stored impact data set includes impact time information.

16. An impact recording system, comprising:
an impact recording sensor, comprising:
an impulse sensing system configured to sense impacts experienced by the impact recording sensor in three dimensions; and
a microcontroller unit (MCU) configured to obtain impact data from the impulse sensing system and store an impact data set including the impact data in memory in response to an impact experienced by the impact recording sensor; and
a control interface unit configured to communicatively couple with the impulse recording sensor, the control interface unit further configured to download the impact data set stored in memory.

17. The impact recording system of claim 16, wherein the impulse recording sensor further comprises a rechargeable power source configured to supply power to the MCU.

18. The impact recording system of claim 17, wherein the control interface unit is further configured to couple with the impulse recording sensor to recharge the rechargeable power source.

19. The impact recording system of claim 16, further comprising a computing device configured to communicatively couple with the control interface unit, the computing device configured to access the downloaded impact data set.

20. The impact recording system of claim 19, wherein the computing device is further configured configure the impulse recording device through the control interface unit.
